(19) United States
(12) Patent Application Publication
(10) Pub. No.: US 2014/0168839 A1
(43) Pub. Date: Jun. 19, 2014

(54) MOTHERARD PROTECTION CIRCUIT

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: SHAO-BO ZHANG, Wuhan (CN); JIAN-HUNG HUNG, New Taipei (TW)

(21) Appl. No.: 13/914,642

(22) Filed: Jun. 11, 2013

(30) Foreign Application Priority Data
Dec. 18, 2012 (CN) 2012105520662

(51) Int. Cl. H02H 3/32

(52) U.S. Cl. CPC H02H 3/325
USPC 361/86

(57) ABSTRACT

A protection circuit includes an embedded control chip (ECC) which includes detecting pins, each of which is connected with one of working chips of a motherboard to read a working voltage of the working chip, first control pins, each of which is connected with an enable pin of one of voltage chips of a voltage supply module, and a second control pin connected to a power button pin of a Southbridge of the motherboard. Each voltage chip provides an input voltage. Each working voltage is one of the input voltages. The ECC compares each working voltage with an associated standard range, outputs a first abnormal signal to the enable pin of the voltage chip which provides an abnormal working voltage to disable the voltage chip, and outputs a second abnormal signal to the power button pin of the Southbridge to turn off the electronic device.

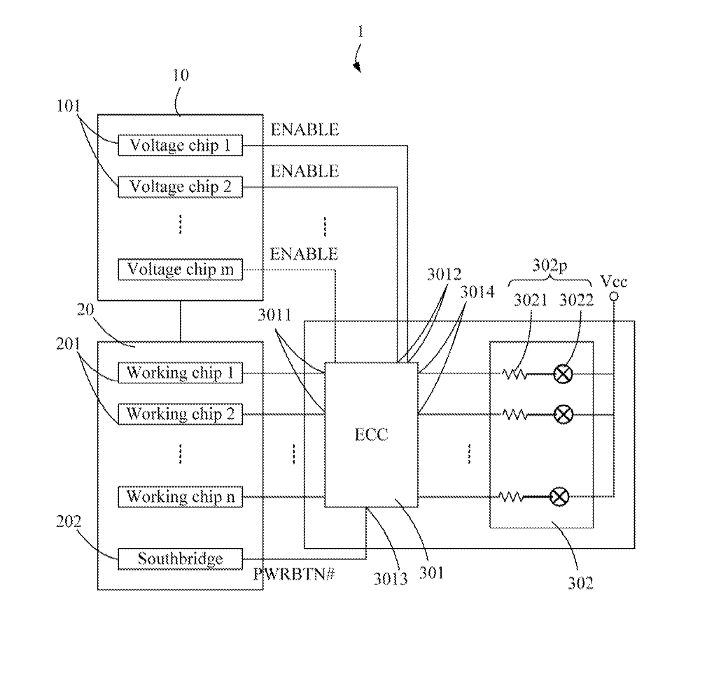

### BACKGROUND

1. Technical Field

The present disclosure relates to protection circuits and, more particularly, to a protection circuit to protect motherboards from being damaged when working voltages are abnormal.

2. Description of Related Art

Motherboards in computers are easily damaged when working voltages are abnormal, for example, when working voltages are interrupted or spike high. Also, it is difficult to know where the working voltage is abnormal, which increases investigation and repair difficulties.

Therefore, it is desirable to provide a protection circuit to protect motherboards from being damaged when working voltages are abnormal.

### BRIEF DESCRIPTION OF THE DRAWINGS

The drawing is a schematic diagram showing a protection circuit in an embodiment.

### DETAILED DESCRIPTION

Embodiments of the disclosure will be described with reference to the drawing.

Referring to the drawing, a protection circuit 30 is connected to a voltage supply module 10 and a motherboard 20. The voltage supply module 10, the motherboard 20, and the protection circuit 30 may be applied in an electronic device 1, such as a computer.

The voltage supply module 10 includes several voltage chips 101 such as voltage regulators for supplying different input voltages, such as 1.2V, 1.5V, 3V, and 5V. In this embodiment, the number of the voltage chips 101 is m (m is a positive integer). Each voltage chip 101 includes an enable pin ENABLE for enabling or disabling the voltage chip 101. When the voltage chip 101 stops outputting the corresponding input voltage when disabled.

The motherboard 20 is connected to the voltage supply module 10 to obtain the input voltages and includes several working chips 201 and a Southbridge 202. The number of the working chips 201 in this embodiment is n (n is a positive integer). Each working chip 201 works properly when a working voltage, which is one of the input voltages, supplied thereto falls within a predetermined range and malfunctions, or even is damaged, when the working voltage exceeds the predetermined range, that is, the working voltage is abnormal. The Southbridge 202 includes a power button pin PWRBTN# and is configured to shut down the electronic device 1 when the power button pin PWRBTN# is signaled.

The protection circuit 30 includes an embedded control chip (ECC) 301 and an indicating circuit 302.

The ECC 301 includes a number of detecting pins 3011, a number of first control pins 3012, a second control pin 3013, and a number of third control pins 3014.

The number of the detecting pins 3011 is same as the number of the working chips 201. Each of the detecting pins 3011 is connected to one of the working chips 201 to read the working voltage of one of the working chips 201.

The number of the first control pins 3012 is same as the number of the voltage chips 101. Each of the first control pins 3012 is connected to the enable pin ENABLE of one of the voltage chips 101.

The second control pin 3013 is connected to the power button pin PWRBTN# of the Southbridge 202.

The number of the third control pins 3013 is same as the detecting pins 3011. Each third control pin 3014 is associated with one of the detecting pins 3011.

All of the detecting pins 3011, the first control pins 3012, the second control pin 3013, and the third control pins 3014 of the ECC 301 may be general purpose input/output (GPIO) pins.

The indicating circuit 302 includes a number of paths 302p. The number of the paths 302p is the same as the number of the third control pins 3014. Each path 302p includes a current limiting resistor 3021 and an indicator 3022 such as a light emitting diode connected in series between one of the first control pins 3012 and a voltage source Vcc.

The ECC 301 is configured to compare each working voltage with an associated standard voltage range, which can be prestored in the ECC 301. If any of the working voltages is below or above the associated standard range, the working voltage is regarded as abnormal, and the ECC 301 outputs a first abnormal signal such as a logic-high level to the enable pin ENABLE via the corresponding first control pin 3012 to disable the voltage chip 101 which provides the abnormal working voltage. The ECC 301 also generates a second abnormal signal such as a logic-low level to the power button pin PWRBTN# of the Southbridge 201 via the second control pin 3013 to turn off the electronic device 1. The ECC 301 further outputs a third abnormal signal such as a logic low level to turn on the indicator 3022 via the corresponding third control pin 3014 associated with the detecting pin 3011 which detects the abnormal working voltage.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A protection circuit for use in an electronic device which comprises a voltage supply module and a motherboard connected with the protection circuit, the protection circuit comprising:
an embedded control chip (ECC) comprising:
a plurality of detecting pins, wherein, in use, each of the detecting pins is connected with one of working chips of the motherboard, to read a working voltage of the working chip;
a plurality of first control pins, wherein, in use, each of the first control pins is connected with an enable pin of one of voltage chips of the voltage supply module, each voltage chip provides an input voltage when enabled, each working voltage is one of the input voltages; and
a second control pin to be connected to a power button pin of a Southbridge of the motherboard,
wherein, in use, the ECC is compares each working voltage with an associated standard range, define the working voltage falling out of the associated standard range as an abnormal working voltage, output a first abnormal signal to the enable pin of the voltage chip which provides the abnormal working voltage via the corresponding first control pin to disable the voltage chip, and output a second abnormal signal to the power button pin of the Southbridge to turn off the electronic device via the second control pin.

2. The protection circuit according to claim 1, wherein the ECC further comprises a plurality of third control pins, each of the third control pins is associated with one of the detecting pins, the protection circuit further comprises an indicating circuit, the indicating circuit comprising a plurality of paths, each of the paths comprises a resistor and an indicator connected in series between one of the third control pins and a voltage source, in use, the ECC outputs a third abnormal signal to turn on the indicator via the first control pin associated with the detecting pin which detects the abnormal working voltage.

3. The protection circuit according to claim 2, wherein all of the detecting pins, the first control pins, the second control pin, and the third control pins are general purpose input output GPIO pins.
